(19) United States
(12) Patent Application Publication
(10) Pub. No.: US 2004/0138949 A1
(43) Pub. Date: Jul. 15, 2004

(54) Sponsored appliances

(76) Inventors: James E. Darnton, St. Joseph, MI (US); Melodie A. Nakhle, Chicago, IL (US); Philip Pejovich, St. Joseph, MI (US); William A. Dunwoodie, Stevensville, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 10/719,111

(22) Filed: Nov. 21, 2003

Related U.S. Application Data
(60) Provisional application No. 60/319,760, filed on Dec. 6, 2002.

(51) Int. Cl. G06F 17/60

(52) U.S. Cl. 705/14; 705/1

(57) ABSTRACT

The present invention is a method of creating a sponsored appliance. The method comprises the steps of creating a sponsored relationship between an appliance sponsor and an appliance seller, incorporating sponsorship material into the appliance, and providing the sponsored appliance with purchase incentive as a result of the sponsorship.

This application claims priority to Provisional U.S. Patent Application No. 60/319,760 filed Dec. 6, 2002 entitled Sponsored Appliances.

### FIELD OF THE INVENTION

In general, the invention relates to sponsored products, whose sponsorship enhances the marketability of the product. In one aspect, the invention relates to a sponsored appliance. In another aspect, the invention relates to a method of selling sponsored appliances by using the sponsorship to create a purchase incentive. In another embodiment, the invention relates to a sponsored public service message to encourage healthy habits, such as, but not limited to eating or exercising.

### DESCRIPTION OF THE RELATED ART

Sellers of consumer products of all types compete aggressively for the end consumer. Sellers take many different approaches to differentiate their products from the competition on price and/or functionality to provide an incentive for the consumer to purchase their product.

The efforts to differentiate products is complicated in that a particular Seller often has a variety of different products, some of which are related, and some of which are not. For example in the consumer products subset of consumer appliances, there are many different types of appliances, including, without limitation, clothes washers, clothes dryers, refrigerators, freezers, combination refrigerator freezers, ranges, cooktops, ovens, microwaves, toasters, mixers, blenders, and more. New products, improvements to current products, and combinations of current products are being continuously developed.

Differentiation is more difficult in mature products, such as home appliances, where there has been a long history of simultaneously creating products with greater functionality at the same or reduced price. In these mature product markets, profit margins are relatively small and no one competitor has a substantial functionality advantage over the others. Thus, it is difficult to differentiate a product solely on price since many consumer's view the products as commodities.

For all consumer product markets and especially for mature markets like the home appliance market, an increase in the value of the product is one way to differentiate products. In the home appliance market the traditional measure of value is the inherent value of the appliance, which includes factors such as: price, quality, functionality, and brand recognition.

However, changing the inherent value of an appliance is very difficult because of the relative inability to adjust these factors in a substantial way that differs from the competition since almost all home appliance manufacturers have the same or similar cost structures and functionality.

Therefore, there is a desire to have an appliance configuration and/or business methodology that enhances the value of the appliance to the consumer to create a purchase incentive and which is not dependent on the manufacturer's cost structure.

### SUMMARY OF THE INVENTION

One embodiment of the present invention is a method of creating a sponsored appliance. The method comprises the steps of creating a sponsored relationship between an appliance sponsor and an appliance seller, incorporating sponsorship material into the appliance, and providing the sponsored appliance with purchase incentive as a result of the sponsorship.

Another embodiment of the present invention is also a method of creating a sponsored appliance. In this embodiment the method comprises the steps of creating a sponsored relationship between an appliance sponsor and an appliance seller, providing a consumer with sponsorship material configured to be placed in the appliance, and providing the consumer with an incentive to accept the sponsorship material. Yet another embodiment of the present invention is a method of sponsoring a healthy refrigerator. In this embodiment, the method comprises the steps of creating a sponsored relationship between a refrigerator sponsor and a refrigerator seller, and incorporating a healthy habits message sponsored by the refrigerator sponsor into the refrigerator. Here, a consumer is reminded of the healthy habits message with every use of the refrigerator.

Another embodiment of the invention is a method of sponsoring a healthy refrigerator. In this embodiment, the method comprises the steps of creating a sponsored relationship between a refrigerator sponsor and a refrigerator seller and designing the refrigerator for allowing healthy foods to be more easily seen and accessed. Here, a consumer is reminded to eat healthy foods with every use of the refrigerator.

### BRIEF DESCRIPTION OF THE DRAWINGS

FIG. 1 is a diagram illustrating the method and relationships for creating and selling a sponsored appliance according to the invention.

FIG. 2 is a perspective view of a representative sponsored appliance in the form of a refrigerator/freezer incorporating general and specific sponsorships.

FIG. 3 is a flow chart illustrating the major steps in the method for creating and distributing a sponsored appliance according to the invention.

FIG. 4 is a diagram illustrating a preferred sponsor selection process in the form of a bidding process that is used to select one or more sponsors for the sponsored appliance according to the invention.

FIG. 5 is a flow chart illustrating the major steps of the design process for incorporating the sponsorship into an appliance in accordance with the invention.

FIGS. 6-11 illustrate a variety of sponsorships ranging from traditional advertising to sponsor modules set in the context of the refrigerator/freezer.

FIGS. 12 and 13 illustrate an embodiment of a sponsorship appliance having a theme that provides the appliance with functionality and utility beyond the sponsorship.

### DESCRIPTION OF THE PREFERRED EMBODIMENT

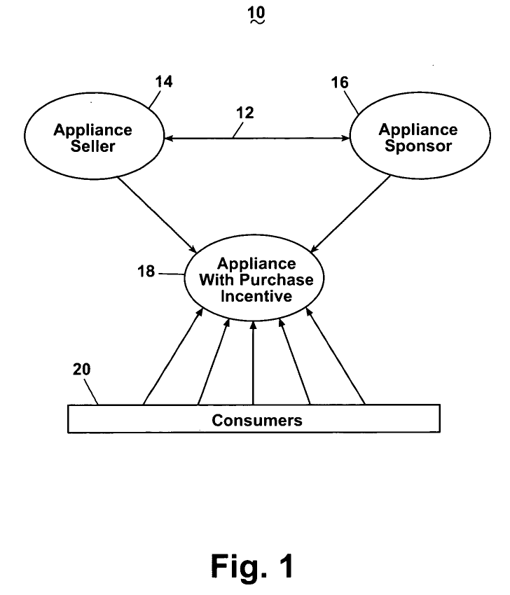

FIG. 1 diagrammatically illustrates the general method for marketing a sponsored appliance according to one aspect of the present invention. The method 10 begins with the creation of a sponsorship relationship 12 between an appliance seller 14 and an appliance sponsor 16. The result of the sponsorship relationship 12 is to create a sponsored appliance 18 having a purchase incentive attributable to the sponsorship by the appliance sponsor 16. The purchase incentive for the sponsored appliance provides an additional incentive for consumers 20 to purchase the appliance above and beyond the intrinsic value of the appliance without the sponsorship.

Illustrative Appliance

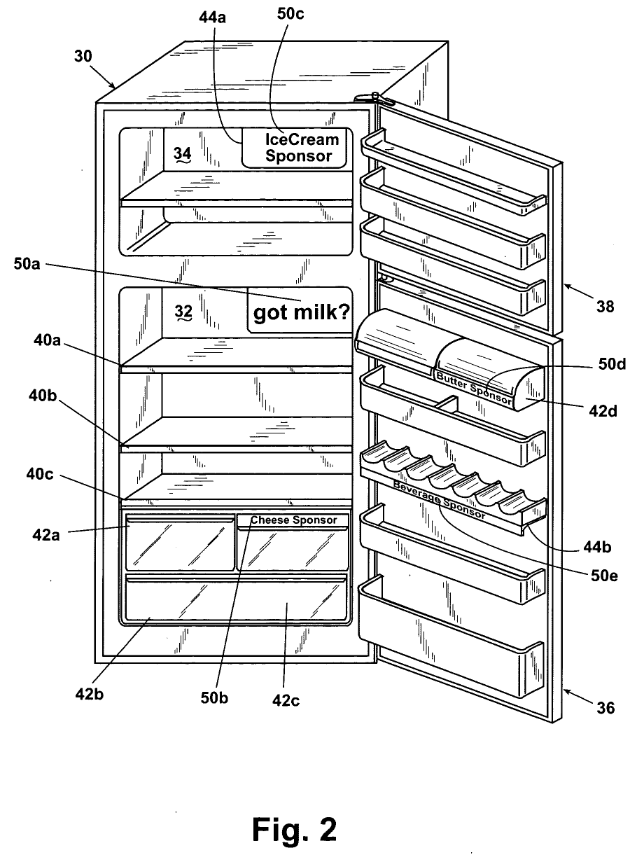

For ease of understanding, the details of a sponsored appliance and method 10 of creating a sponsored an appliance will be described with reference to an illustrative sponsored appliance 18, which is shown in FIG. 2 as a refrigerator/freezer 30 in accordance with the invention. It is to be understood that the refrigerator/freezer 30 is only one example of a sponsored appliance 18 in accordance with the invention. Any other appliance can also be used.

The refrigerator/freezer 30 comprises a refrigerator compartment 32 and a freezer compartment 34, which are closed by doors 36, 38, respectively. The refrigerator/freezer may comprise a series of shelves 40a-c, bins 42a-c, and/or product modules 44a-b. Sponsorship in the form of sponsorship material such as printed advertising 50a-e or the like is disposed adjacent to or on some of the shelves 40, bins 42, and product modules 44. The printed advertising may be in the form of logos, interchangeable inserts, magnets, stickers, coupons, or any other variety of sponsorship material.

Types of Sellers

In the preferred embodiment, the seller 14 is an original equipment manufacturer (OEM) appliance manufacturer. However, other types of sellers 14 are within the scope of the invention. For example, the seller can be a reseller, such as a wholesaler. The seller need not necessarily manufacture the product, although it is preferred. The seller can also be a retailer who provides the point of sale location for selling the appliance 18 to the consumer 20. In its most general form, the appliance and the method 10 are not limited to the type of seller as any seller will suffice.

### Types of Sponsors

The sponsor 16 is preferably a consumer products company (CPC), which preferably markets consumer products that are relevant to or related to the sponsored appliance 18. It is believed that the more relevant to or related the sponsorship is to a particular appliance, the more the consumer will view the sponsorship as adding value to the appliance. While it is preferred, it is not necessary for purposes of the invention that the products marketed by the CPC be relevant to or related to the sponsored appliance 18.

For the refrigerator/freezer 30, suitable CPC sponsors can include, for example, any food processors, such as DOLE, TROPICANA, MINUTE MAID, KRAFT, NABISCO, NESTLE, and beverage producers, such as Coca-Cola, Pepsi-Cola, and 7 UP. These sponsors can be referred to as product-specific or specific sponsors.

For the typical CPC, the sponsorship may be a traditional print advertisement on a suitable surface of the appliance, such as, for example, the “got milk?” ad 50a located on the rear wall of the refrigerator compartment 30. The advertising can also be in the form of a logo, such as the “Cheese Sponsor” logo 50b or the “Butter Sponsor” logo 50d on the bins 42c and 42d, respectively. Additionally, the sponsorship can also be in the form of a specifically designed module, such as the modules 44a and 44b, which are designed to cooperate with the particular packaging of the sponsor. For example, the module 44a is an ice cream dispenser designed to dispenser the ice cream of the “Ice Cream Sponsor” 50c. The module 44b is a shelf that is specifically designed to hold beverage cans made by the “Beverage Sponsor” 50e.

It is preferred that the modules 44a-44b be designed to specifically accommodate the product packaging for the sponsor. While, it is within the scope of the invention for the modules to accept only the packaging of the sponsor, the invention is not limited to such an embodiment.

The sponsor 16 need not be a CPC in general, nor need it be a CPC to have relevance to or relate to the sponsored appliance 18. For example, the sponsor could be an industry group such as the National Dairy Council, which represents milk producers and has a well-known “got milk?” advertising campaign. These sponsors can be thought of as general sponsors. Other such organizations in the food producer business relevant to the refrigerator/freezer could include the National Pork Board (the “Pork, the other white meat” ad campaign.), and Ocean Spray, which represents cranberry growers, to name a few.

Other sponsors might include public health organizations such as The Center for Disease Control, National Cancer Institute, The American Heart Association, or the Department of Agriculture. These sponsors may promote a “healthy fridge” by sponsoring healthy habits messages to consumers.

Other sponsors may be general service provides. In particular, it is contemplated that the YMCA or other fitness organizations may sponsor an appliance, whereby purchasers of the appliance may receive free memberships or limited time memberships. Other examples of service providers may be music or game providers. For these providers it is contemplated that these providers sponsor a CD containing music or games and in return the CD would include a copy of the appliance's Use and Care guide.

Lastly, utility companies and government agencies may also desire to be sponsors. These sponsors may promote Energy Efficiency Programs by encouraging consumers to replace inefficient and outdated appliances.

Types of Purchase Incentives

The purchase incentives can also vary dramatically. In the most basic form, the purchase incentive is a direct incentive, such as a monetary payment from the sponsor 16 to the seller 14, which the seller 14 uses to subsidize or decrease the sale price of the appliance 18. The price of the appliance 18 can be decreased by all or a portion of the payment from the sponsor 16 to the seller 14. In a best case scenario, it is possible that advertising revenue may be sufficient to off-set the costs of manufacturing low-end appliances, even low-end refrigerators. In this case, it may be possible for the manufacture to actually give away the appliance, which ensures the advertiser's message reaches its desired audience. The purchase incentive can also be an indirect incentive. One example of an indirect incentive is the value that the consumer places in the brand recognition of the sponsor 12 or the loyalty the consumer as to the sponsored brand. Another indirect incentive would include the sponsor adding something of value to the appliance, examples of which include the extra functionality of the product modules or coupons and the like for the sponsor's goods or services.

The coupon dispenser can dispense a physical coupon that the consumer can redeem. Alternatively, the coupon dispenser could electronically store a coupon or cash-back amount to the consumer smart card, credit card, debit card, or sponsors card. Similarly, the coupon dispenser could be connected to a computer network, including the Internet, for directly crediting an account of the consumer's, especially an account used to purchase the goods and services of the sponsor. For example, such an account might be linked to a grocery store where the consumer would purchase the goods of the sponsor.

Another example of purchase incentive may be to provide the consumer with a public service message or a healthy habits message such as eating healthy. For example, the American Heart Association might sponsor a message in a refrigerator which encourages healthy eating habits such as eating five servings of fruits and vegetables per day to lower the risk of heart disease, diabetes and other diseases. This is one way the American Heart Association may be able reach consumers other than through television advertisements. Preferably, the healthy habits message is located in a position that is readily viewable by an operator of the appliance, such as, in the case of a refrigerator, on the side of the refrigerator door at about eye-level.

Another example of a purchase incentive may be to provide the consumer with a refrigerator containing certain modules that make healthy foods more accessible of easily seen such as a milk dispenser. Organizations such as the Dairy Association may sponsor such a dispenser. Such organizations could even change their packaging to fit new generations of dispensers.

In addition to healthy eating habits, the healthy fridge may also promote exercise or other healthy living styles. Accordingly, it would make sense for service providers such as the YMCA or other fitness organization to promote their service through a sponsored appliance, such as by providing discounted or limited time memberships.

Specific Details of Sponsorship

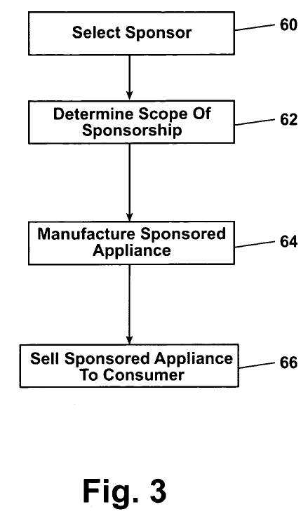

FIG. 3 illustrates the major steps in the appliance sponsorship method 10 according to the invention. The appliance sponsorship method 10 begins with the selection of an appropriate sponsor at 60. Once an appropriate sponsor has been selected, it is necessary to determine the scope of the sponsorship at 62 for the selected sponsor. The determination of the scope of the sponsorship at 62 relates to the manufacture of a sponsored appliance at 64 that conforms to the scope of the sponsorship 62 for selected sponsor at 60. The appliance manufactured at 64 is then sold to the consumer 20 at 66.

Each of the major steps 60-66 can contain substantial detail in their implementation. For example, the selection of a sponsor at 60 can take many forms. The sponsor selection can be a traditional arms-length negotiation between the seller and the sponsor. In such a direct arms-length negotiation, the seller 14 will typically approach the sponsor 16 and solicit the sponsorship 12. However, it is contemplated that in some instances the sponsor 16 will solicit the seller 14.

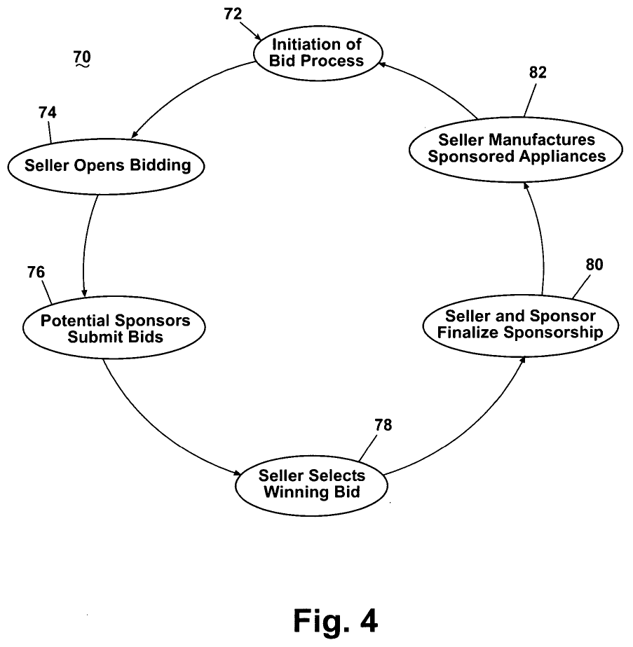

FIG. 4 illustrates the preferred methodology for selecting the sponsor at 60. The preferred methodology is a bidding process 70. The initiation of the bidding process 70 begins at step 72. While any suitable temporal milestone can be selected as the initiation time for the bidding process and step 72, it is preferred that the initiation of the bidding process occurs as the seller approaches a natural break in the production cycle of one or more appliances. In this manner, the sponsored appliance that results from the bidding process can be designed, built and distributed by the seller 14 without disrupting the seller's normal production cycle.

Upon the initiation of the bidding process at step 72, the seller opens the bidding at 74. Preferably, the opening of the bidding includes the sending of a notice by the seller to potential sponsors. The notice can include a list of general information, such as model type, expected natural life, estimate of amount of units to be produced, and other relevant information for the particular appliance.

Optionally, the notice may also include the setting of a benchmark price for the sponsorship. One factor that can be used in setting the benchmark price is the total number of times a sponsored brand is likely to be seen (a/k/a impressions) during the life-cycle of the appliance. For example, in the case of the refrigerator/freezer 30, the number of impressions can be equated with the number of times that the door is opened.

In response to the opening of the bidding at 72, the potential sponsors submit their bids to the seller at 76. The bids can take many forms and have many levels of detail depending on the desires of the potential sponsor and the scope of the notice. It is anticipated that most bids would include the sponsorship price, appliance design criteria, the sponsor's packaging requirements, and coordination between the sponsors packaging and the appliance design.

Once the seller 14 has collected the bids submitted by the potential sponsors at 76, the seller 14 selects the winning bid at 78 based on criteria relevant to the seller. It is anticipated that the seller 14 will assess the overall value of the bid including such factors as the bid price and the efficacy of the sponsorship. A high bid price will be of little value if the sponsorship does not increase the value of the appliance to the consumer.

The seller and sponsor finalize the terms and scope of the sponsorship at 80 after the seller 14 selects the winning bid at 78. The terms and scope of the sponsorship at 80 include determining the amount, timing, and manner of any monetary payments to be made to the seller 14 by the sponsor 16. The seller and sponsor also determine whether the sponsorship 12 will be a general or specific sponsorship and whether that general or specific sponsorship will be implemented through a direct or indirect purchase incentive. To the extent the specific sponsorship 12 requires design changes to the appliance or the creation of a sponsor module, such as modules 44a-44b, the design process and responsibility for the creation of the sponsor module should be determined as part of the finalization of the sponsorship relationship.

The seller 14 then manufactures the sponsored appliance at 82 in accordance with the terms and scope of the sponsorship as finalized at 80. The manufacture of the sponsored appliance continues for the time-period or number of units agreed upon at 80. The cessation of the sponsorship for the sponsored appliance will typically coincide with a natural break in the appliance production cycle or create the natural breaking in the appliance production cycle.

As the manufacturing of the sponsored appliance nears the natural break in the production cycle, the bidding process 70 is started over at 72 by the initiation of a new bidding process. The process can be continuously repeated.

It is worth noting that any particular bidding process 70 can vary in scope from previous bidding processes. For example, a particular bidding process may involve a single appliance sold by the seller 14, multiple appliances sold by the seller 14, or a family or subset of appliances sold by the seller 14. It is also contemplated that the bidding process may result in the appliance or appliances, as the case may be, having multiple sponsors or an exclusive sponsor.

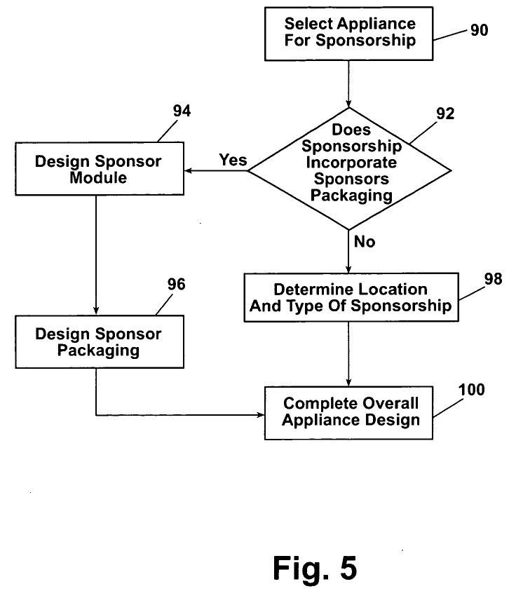

FIG. 5 illustrates the major process steps for designing an appliance in accordance with the terms and scope of the sponsorship. The process outlined in FIG. 5 can apply regardless of the process by which the sponsor is selected.

The designing of the sponsored appliance begins by selecting the appliance or appliances to be sponsored at step 90. The process outlined in FIG. 5 is applied to each of the appliances sponsored by the sponsor 16. For purposes of this description, it is assumed that only a single appliance is sponsored.

It is anticipated that most cases the type of sponsorship will be in a form of traditional advertising, such as a logo or slogan, relating to a brand of the sponsor and the determination of the most suitable location for the advertising. For example, in one embodiment, it is contemplated that a sponsor's logo or advertisement might be placed on the shelf or back wall of a refrigerator so that the logo or advertisement only shows when the shelf is empty. Another example, may be to provide pre-selected “areas” in a number of locations throughout the appliance for placement of advertisement. In a non-limiting, preferred embodiment, a refrigerator may designed with fixed plastic holders in various locations next to shelves, modules, or the like. Pre-selected logos or advertisements may be interchangeable in each of the fixed plastic holders to allow the owner of the refrigerator to organize the refrigerator as desired. It is also contemplated that a user may be able to access a web-site that allows the user to print out any variety of labels for customizing the refrigerator. It should be recognized that the labels could be sized to fit any particular area, or could be sized to fit within the plastic holders for interchangeable use within the refrigerator.

In an alternative embodiment, an initial determination is made at 92 whether the scope of the sponsorship incorporates making special accommodations for the sponsor's packaging. It is anticipated that in most cases where the sponsors packaging must be accommodated, it most likely will necessitate the design of a sponsor-specific module as illustrated at 94. The design of the module at 94 can be done to accommodate the sponsor's current packaging or the simultaneous development of the design of new packaging for the sponsor as illustrated at 96. While not shown, the design of the product module and sponsor packaging will most likely be an iterative process.

Once the sponsor module and sponsor's packaging are designed at 94 and 96 or the location and type of the sponsorship are determined at 98, the sponsorship elements are integrated into the overall appliance design at 100. The seller typically will oversee the integration as part of the product cycle.

It should be noted that while the incorporation of a sponsor module and/or sponsor packaging at 94 and 96 are illustrated in the alternative relative to the determination of the location and type of sponsorship at 98, it is within the scope of the invention for a single sponsor to incorporate both branches of the method. That is, any one particular sponsor may have traditional advertising in combination with a sponsor module.

In a case of multiple sponsors for a single appliance, it is contemplated that the design of the sponsored appliance will require the cooperative effort of the seller and all of the sponsors. For example, if each of the multiple sponsors desires a sponsor module that incorporates the sponsor's packaging, steps will be taken to prevent one sponsor module from negatively impacting the value added by another sponsor module or the functionality of another sponsor module. The same holds true in the selection of the location and type of sponsorship, such as traditional advertising.

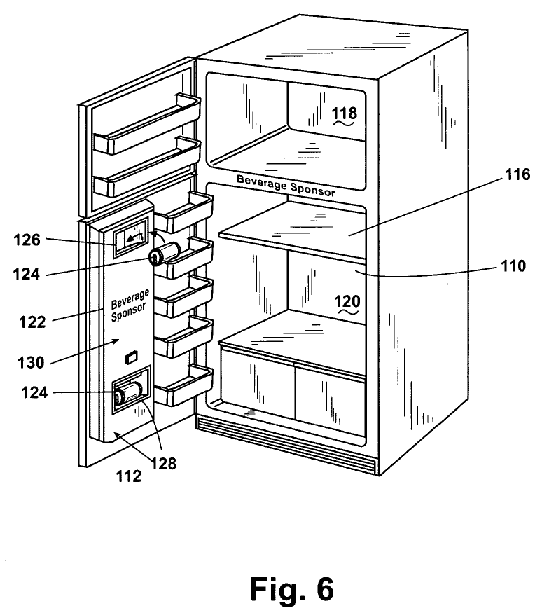

FIGS. 6-11 illustrate a variety of sponsorships ranging from traditional advertising to sponsor modules. The illustrated sponsorships will be described in sequence. However, it should be understood that no one sponsorship is necessarily preferred over another and that the sponsorships are merely illustrative of the variety of sponsorship available.

FIG. 6 illustrates two sponsorships 110 and 112 in a refrigerator/freezer 114. The sponsorship 110 is a general sponsorship comprising an advertisement that is located on the wall 116 separating the freezer compartment 118 from the refrigerator compartment 120.

In contrast, the sponsorship 112 is a specific sponsorship in the form of a sponsor module for dispensing canned beverages. The beverage dispenser comprises a housing 122 that defines a storage recess for housing cans of beverage 124. The housing 122 includes an inlet 126 for inserting the beverage cans 124 into the hollow interior of the housing 122. An outlet 128 is provided for removing the beverage cans 124 that are stored within the housing 122. A suitable advertising 130 for the sponsor is provided on the housing 122.

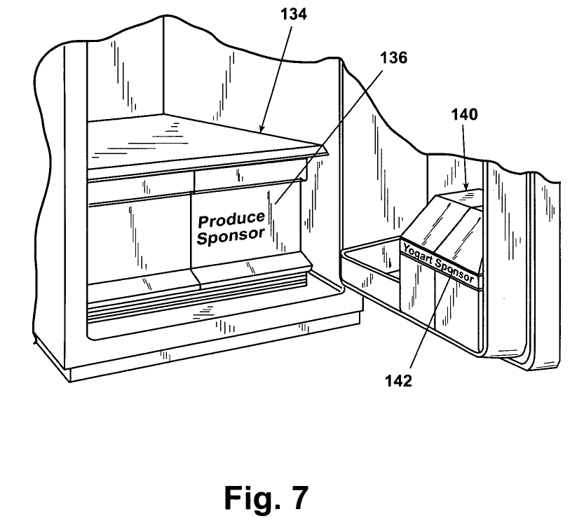

FIG. 7 illustrates a sponsorship in the form of a slidable drawer or bin 134 that is suitable for storing fruits and/or vegetables and on which is provided an advertising 136 for the sponsoring produce company, resulting in a specific sponsorship by the produce company.

A sponsor module in the form of a reclosable storage bin 140 is also shown in FIG. 7. The reclosable storage bin 140 is ideally designed to accommodate individual servings of yogurt and similarly sized items. A suitable advertising 142 is disposed on the face of the storage bin 140 to indicate the sponsorship of the storage bin 140 by a food processor.

With respect to FIG. 7, it is also contemplated that the produce drawer 134 in the storage bin 140 can either individually or collectively be identified or sponsored as a “healthy food compartment” or other similar title. The benefit of which is that a parent can instruct a child to take a snack from the healthy food compartment to improve the eating habits of the child.

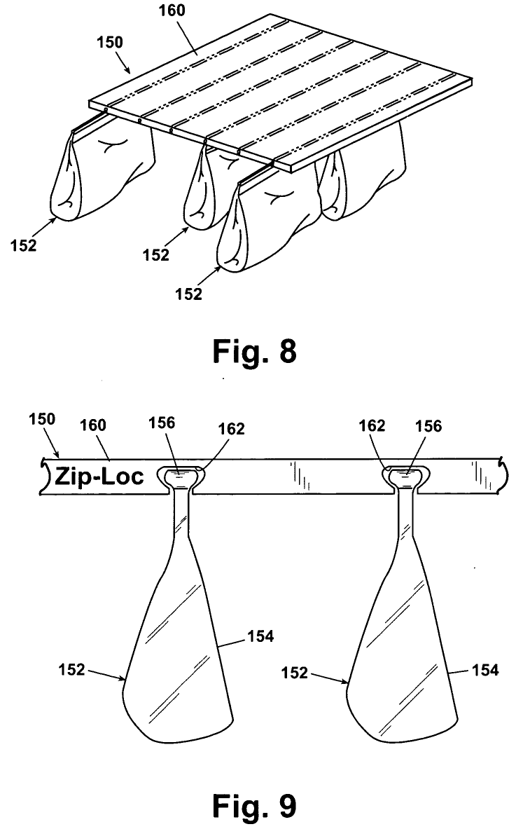

FIGS. 8-9 illustrate another alternative sponsor module 150, which is ideally suited for a packaging manufacture. More specifically, the sponsor module 150 is specifically designed to hold reclosable plastic food bags 152 of which a well-known brand type is Ziploc. Such food bags 152 have a main body 154 that terminates in an upper seal 156 whose shape provides the bag with an enlarged cross-section. The sponsor module 150 takes advantage of the enlarged cross-section to securely suspend the food bags 152.

Preferably, the sponsor module 150 is a shelf 160 suitable for mounting in a refrigerator. The shelf includes multiple channels 162 having a cross-section that conforms to the enlarged cross-section of the food bags 152. The channels 162 extend along the length of the shelf 160 and open onto the shelf face to aid in the slidable insertion of the enlarged cross-section of the seal 156 into the corresponding channel 162 on the shelf 160.

With this connection, the food bags 152 can be filled with the desired food item and suspended from the shelf by slidably inserting the enlarged cross-section into the channel. This structure provides for a neat an orderly arrangement of the food bags 152 in the refrigerator. The suspension of the food bags 152 also reduces the likelihood that the contents of the bag will spill or leak from when laid on their side in refrigerator, which is their typical storage position.

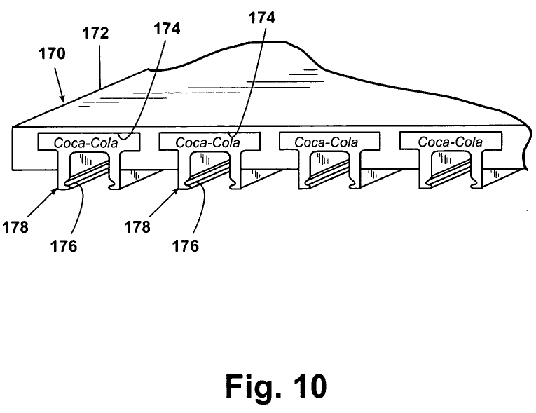

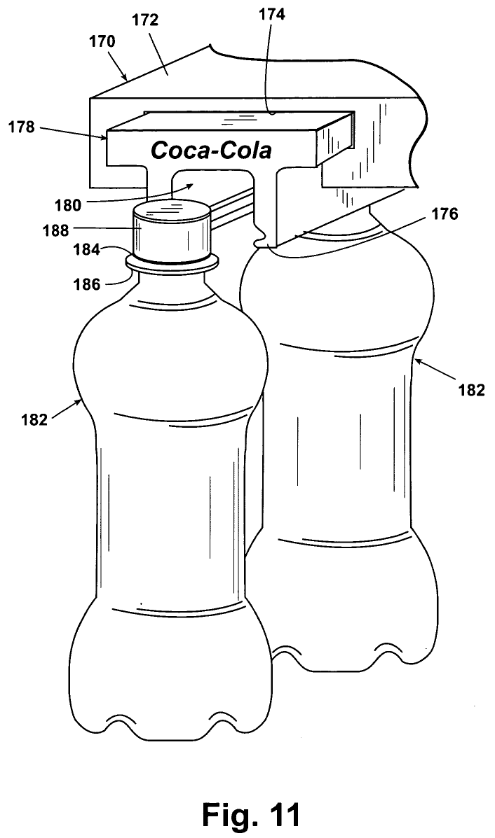

FIGS. 10 and 11 illustrate a sponsor module 170 that is conceptually similar to the module 150. The sponsor module 170 is also preferably a shelf 172 in which are formed multiple T-shaped channels 174 in which are slidably received custom container mounts 176. The custom container mounts have an outer T-shaped cross-section that permits them to be slidably received within a corresponding T-shaped channel 174. The custom mounts 178 define an inner channel 180 whose shape conforms to a portion of a product to be mounted within the inner channel 180.

One possible product suitable for use in mounting within the inner channel 180 is a plastic beverage container 182 having a threaded neck 184 terminating in a collar 186. A cap 188 is threaded onto the neck 184 and seals relative to the neck 184 prior to reaching the collar 186. The cross-section of the inner profile 180 conforms to the cross-section of the neck 184 and collar 186. With this configuration, the beverage container 180 can be slidably mounted within the inner channel 180 to suspend the beverage container 182 from the shelf 172.

The shelf 172 illustrated in FIGS. 10 and 11 has a significant advantage over the shelf 160 illustrated in FIGS. 8 and 9 because of the removable custom mount 178. The removable custom mount 178 provides the shelf 172 with much greater flexibility in that an entirely new shelf need not be designed to accommodate a different product. Instead, only product-specific custom amounts 170 need be made when it is desired to mount a different product to the shelf 172.

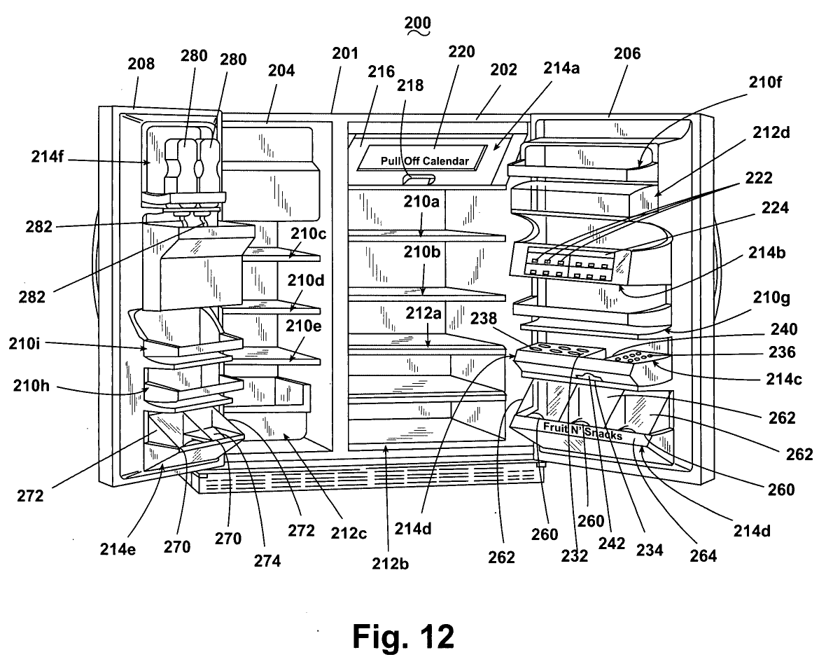

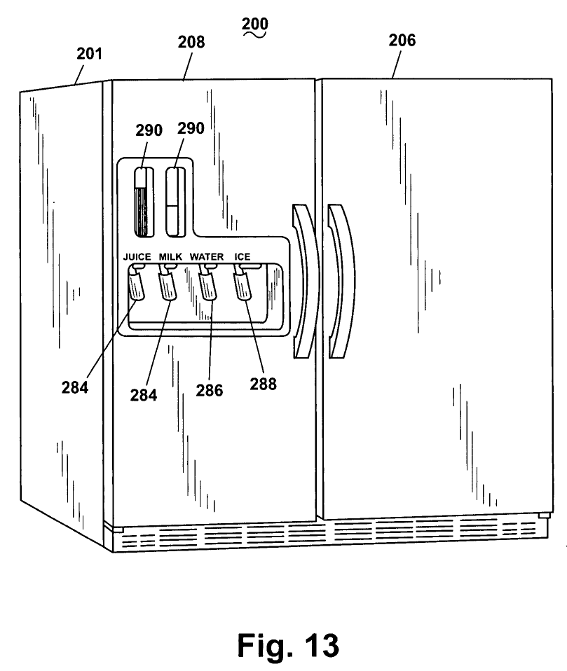

FIGS. 12 and 13 illustrate a themed sponsored appliance in the form of a refrigerator that expands the healthy food compartment concept of FIG. 7 into a healthy refrigerator 200. The thematic approach of the healthy refrigerator 200 provides functionality and utility beyond the benefits of the sponsorship alone. The healthy refrigerator 200 is designed to encourage and facilitate a healthy lifestyle. The refrigerator 200 helps address a consumer's underlying need and desire to improve their physical health and sense of well being. The healthy refrigerator 200 accomplishes this function by providing the consumer with gentle reminders about healthy eating, ease of access to healthy foods, and components that encourage healthy eating.

The healthy refrigerator 200 is illustrated in a side-by-side configuration having a cabinet 201 in which are formed a refrigerated compartment 202 and a freezer compartment 204, which are closed by corresponding doors 206, 208, respectively, hingedly mounted to the cabinet. Shelves 210a-i and bins 212a-d are provided in the refrigerated compartment 202, freezer compartment 204, and the corresponding doors 206 and 208.

A variety of sponsored modules 214a-f are provided in the healthy refrigerator 200. Each of the modules 214a-e have specific characteristics that add to the theme and functionality of the healthy refrigerator. The module 214a is primarily for storing desserts and other less healthy foods. The module 214a is located in an upper portion of the refrigerated compartment to keep the contents further out of reach of children. The module 214a comprises a hinged cover 216 having a handle 218. To reach the food within the module, the consumer must lift the cover 216 by the handle. It is preferred that the cover be non-see-through so the consumer cannot easily see what food items are stored within. It is believed that if unhealthy foods are located out of immediate sight of the consumer looking in the refrigerator for food, the consumer will be less likely to pick the unhealthy food as a snack. The module 214a thus has two functional benefits. One, it locates the food out of reach of children. Two, it hides the more unhealthy food from the consumer.

The module 214a can also mount a pull-off calendar 220 or similar device that in addition to a traditional calendar can also provide nutritional guidance for the consumer, most likely in the form of textual messages on the calendar. It can also provide a place for notes by the consumer regarding food consumption. The sponsorship of the module 214a can lie in the textual messages on the calendar. It can also the placement of a logo on the calendar.

While it is contemplated that the calendar 220 is a traditional pull-off calendar, it is within the scope of the invention for the cover 216 to include an electronic display on which the calendar and messages can be displayed. The display can be of any suitable type, such as an LCD or a Gas Plasma Display, for example. The display could be a stand alone device or it could be connected to a network, LAN or WAN to permit the updating of data over the network.

The module 214b is a food counter module. In its most basic form, the module 214b is illustrated as a four quadrant grid having multiple counters 222 located in each grid. It is contemplated that each of the quadrants will be allocated for a different user and that each of the counters 222 will represent a predetermined food groups, such as, for example, DAIRY, GRAINS, and FRUIT. However, other groupings can be selected. For example, the groupings could cover the four levels or seven groups of The Food Guide Pyramid published by the United States Department of Agriculture. The number of counters will vary depending on the number of food groups that are desired to be tracked.

It the simplest form, the counters 222 are numerical counters, such as rotating dials with numerical indicia. The user will rotate the dial to the desired count for the particular food group. The counters 222 can be more complex. It is contemplated that they could be digital counters, for example. The counters could even be linked to the display in the module 214a.

One use of the counters 222 is to track the number of snacks consumed in a particular group. For example, each time the consumer takes a FRUIT snack from the refrigerator, the user increments the counter 222 of the FRUIT group by rotating the dial.

The counters can also be used to track other data than food groupings. For example, many weight loss programs have defined serving sizes for predefined food groups. Other weight loss programs provide points for each food item consumed. The counters can be used to track the number of servings or the number of points for these type of weight loss programs.

Some weight loss programs have custom calculators that upon entry of food data (calories, fat grams, fiber grams, serving size, etc.) will identify the corresponding point value and increment the total points if instructed. The counters 222 can be such a custom calculator. Like the display, the counters 222 could be coupled to a LAN or WAN for updating the data in the counter for transferring the counter data to another device.

In another embodiment of the invention, the use of removable and replaceable magnets may be used instead of counters. Magnets could be used to track snacks consumed, such as each time the consumer eats a fruit or vegetable, a magnet could be placed or removed from a chart showing desired daily intake. As should be recognized, magnets could be used on the interior or exterior of the appliance and special charts/magnets could be designed to track the same information as counters.

The module 214b includes an sponsorship area 224 where the logo or similar sponsorship could be located. However, the sponsorship could be located at any other location on the module 214b.

Module 214c is designed for dispensing dairy products and comprises three sub-modules 232, 234, and 236. As illustrated, sub-module 232 is designed to dispense yogurt cup holders, sub-module 234 is designed to dispense cheese slices, and sub-module 236 is designed to dispense cheese sticks. The sub-module 232 comprises multiple recesses 238 sized to receive an individual yogurt cup. The sub-module 234 has a recess 240 in which multiple individual cheese slices are stored and a slot 242 through which individual cheese slices are removed. The sub-module 236 also has multiple recesses 244 that are sized to receive individual cheese sticks.

While the module 214c is illustrated as comprising sub-modules for yogurt, cheese slices, and cheese sticks, these are just examples of food items that can be dispensed and are not to be considered limiting on the invention. Any other suitable food item can also be dispensed. This is true of all of the modules in the healthy refrigerator 200.

The module 214c is located in a lower portion of the refrigerator to make the foods more easily accessible to children to encourage their selection of healthy foods.

Module 2146d is specifically designed to dispense fruit and vegetables. As illustrated, is divided into three closeable bins 260, which are defined by separate moveable covers 262. Each of the bins is preferably temperature and humidity controlled. The covers 262 are preferably see-through to permit the consumer to see the contents of the bins 260. As illustrated, the bins 260 are designed to hold dried fruit, fresh fruit, and bit-size vegetables.

An sponsorship area 264 is provided on the module 214d below the covers 262. It is contemplated that the logo or slogan of a sponsor could be placed in the area 264. For example the module 214d might be sponsored by a fruit and vegetable producer and the bins 260 would be specifically shaped to accommodate the packaging of the sponsoring fruit and vegetable producer.

Like the modules 214c, the module 214d is located in a lower portion of the refrigerator to make the foods more easily accessible to children to encourage their selection of healthy foods.

Module 214e is similar in configuration to module 214e and is designed for dispensing frozen fruits. The module 214e is divided into two bins 270, each of which includes a moveable cover 272. It is contemplated that one of the bins will house frozen fruits, such as grapes, for example. The other bin 270 has a series of recesses 274 that are designed to hold the stick of a popsicle, preferably made from frozen fruit juice.

Like the modules 214c and 214d, the module 214e is located in a lower portion of the refrigerator to make the foods more easily accessible to children to encourage their selection of healthy foods.

Module 214f is a healthy liquid or drink dispenser and is best seen by looking at both FIGS. 12 and 13. The module 214f is designed to receive drink containers 280 that are specifically designed to work with the dispenser to simplify the dispensing of the drink. The drink containers 280 as illustrated have a dispensing tube 282, which is fluidly connected to a corresponding flow controller 284 on the exterior of the door 208 (see FIG. 13). The flow controller 284 can be as simple as a pinching mechanism for pinching the dispensing tube to shut off the flow of liquid when the drink containers 280 are designed for gravity feed as illustrated. Alternatively, the controller 284 could be a pump coupled to the tube 282 for pumping the liquids from the drink containers 280. The refrigerator 200 also includes flow controllers 286 and 288 for the traditional dispensing of water and ice. In an exemplary embodiment, the dispenser, container and tube would be disposable to maintain hygiene.

The door 208 can have see-through panels 290 corresponding to each of the liquid containers 280. The see-through panels provide the consumer with a visual indicator of the liquid remaining in the corresponding container 280.

The external accessibility of the liquid dispenser increases the ease at which a consumer can have access to the healthy liquids, and, thus, encourage the user to consume healthy liquids. As illustrated, the healthy liquids would include milk and juices. The sponsorship is preferably in the form of the sponsor's packaging for the containers 280 being designed to work with the module 214f.

While the refrigerator 200 is illustrated with specific modules 214a-f that are designed to promote healthy eating, any of the other modules disclosed in the other drawings could be used in combination with the modules 214a-f.

It is worth noting again that while the preferred sponsored appliance and method relates to a refrigerator/freezer, any appliance can be used. The method and structures of the invention as described can be applied to all appliances and non-appliance consumer products for that matter. For example, a clothes washer can be sponsored in the same manner as the refrigerator/freezer. A clothes washer can have both general and specific sponsorships. Examples of specific sponsorship would include sponsorships related to the detergent, bleach, and software dispensers. A dishwasher is an example of yet another suitable appliance. Specific sponsorship of a dishwasher would include the detergent and drying agent dispensers. Both the clothes washer and dishwasher could also have sponsored wash cycles. For example, a suitable delicate wash cycle could be sponsored by a high-quality cloths manufacture or a fine china manufacture.

We claim:

1. A method of creating a sponsored appliance comprising the steps of:
a. creating a sponsored relationship between an appliance sponsor and an appliance seller;
b. incorporating sponsorship material into the appliance; and
c. providing the sponsored appliance with purchase incentive as a result of the sponsorship.

2. The method according to claim 1, wherein the sponsorship material comprises at least one of the following: printed advertisement or healthy habits message.

3. The method according to claim 1, further comprising the step of providing a predetermined location for the sponsorship material.

4. The method according to claim 3, wherein the predetermined location is configured to accommodate only the product packaged by the sponsor.

5. The method according to claim 1, wherein the sponsorship material is configured to be interchangeable in one or more predetermined locations in the appliance.

6. The method according to claim 1, wherein the sponsored appliance is a refrigerator.

7. The method according to claim 1, further comprising the step of incorporating modules which cooperate with a particular packaging design of the sponsor into the appliance.

8. A method of creating a sponsored appliance comprising the steps of:
a. creating a sponsored relationship between an appliance sponsor and an appliance seller;
b. providing a consumer with sponsorship material configured to be placed in the appliance; and
c. providing the consumer with an incentive to accept the sponsorship material.

9. The method of creating a sponsored appliance according to claim 7, wherein the sponsored material comprises at least an advertisement or a healthy habits message.

10. The method of creating a sponsored appliance according to claim 7, wherein the sponsored material is configured to placed in a predetermined location in the appliance.

11. The method of creating a sponsored appliance according to claim 7, wherein the sponsored material is configured to be placed in the appliance at a location desired by the consumers to allow the consumer to customize the location of items within the appliance.

12. The method of creating a sponsored appliance according to claim 7, wherein the sponsored appliance is a refrigerator.

13. The method of creating a sponsored appliance according to claim 7, wherein the step of providing the consumer with an incentive to accept the sponsorship material comprises providing the consumer with purchase incentive.

14. The method of creating a sponsored appliance according to claim 13, wherein the purchase incentive comprises a direct incentive or an indirect incentive.

15. A method of sponsoring a healthy refrigerator comprising the steps of:
a. creating a sponsored relationship between a refrigerator sponsor and a refrigerator seller; and
b. incorporating a healthy habits message sponsored by the refrigerator sponsor into the refrigerator;
whereby, a consumer is reminded of the healthy habits message with every use of the refrigerator.

16. The method according to claim 15, further comprising the step of providing the refrigerator with purchase incentive as a result of the sponsorship.

17. The method according to claim 16, wherein the purchase incentive comprises a direct incentive or an indirect incentive.

18. The method according to claim 15, wherein the healthy habits message is configured to be placed in the refrigerator at a location desired by the consumers.

19. The method according to claim 15, wherein the healthy habits message is configured to be placed in a predetermined location in the refrigerator.

20. The method according to claim 19, wherein the predetermined location is on the side of the refrigerator door at about eye-level for allowing easy visibility to the consumer.

21. A method of sponsoring a healthy refrigerator comprising the steps of:
a. creating a sponsored relationship between a refrigerator sponsor and a refrigerator seller; and
b. designing the refrigerator for allowing healthy foods to be more easily seen and accessed;
whereby, a consumer is reminded to eat healthy foods with every use of the refrigerator.

22. The method of claim 21, further comprising the step of incorporating modules which cooperate with a particular packaging design of the sponsor into the appliance.

23. The method of claim 21, further comprising the step of providing the refrigerator with purchase incentive as a result of the sponsorship.

24. The method of claim 22, wherein the modules are configured to house healthy foods and are designed to be positioned in the refrigerator in a place easily seen and accessed by a consumer.

25. The method of claim 23, wherein the modules are interchangeable in varies parts of the refrigerator to allow a consumer to design the layout of the refrigerator.
